(19) United States
(12) Patent Application Publication
(10) Pub. No.: US 2024/0318732 A1
(43) Pub. Date: Sep. 26, 2024

(54) Pilot Valve and Four-way Reversing Valve

(71) Applicant: ZHEJIANG DUNAN ARTIFICIAL ENVIRONMENT CO., LTD., Shaoxing (CN)

(72) Inventors: Jianjun CHEN, Shaoxing (CN); Haibo LIU, Shaoxing (CN); Yukuan SHAN, Shaoxing (CN); Xiaoping FU, Shaoxing (CN)

(21) Appl. No.: 18/732,428

(22) Filed: Jun. 3, 2024

Related U.S. Application Data
(62) Division of application No. 17/613,087, filed on Nov. 22, 2021.

(30) Foreign Application Priority Data
Jun. 4, 2019 (CN) 201920836179.2
Sep. 30, 2019 (CN) 201921666046.1

(51) Int. Cl. F16K 11/065; F16K 27/08

(52) U.S. Cl. CPC F16K 11/065; F16K 27/08

(57) ABSTRACT

The present disclosure provides a pilot valve and a four-way reversing valve. The pilot valve includes: a valve body, wherein the valve body is a cylinder formed by integrally stretching and having an open end and a closed end, the closed end is defined as a first end, the open end is defined as a second end, the first end of the valve body is provided with an inlet, the valve body is internally provided with a cavity, and the inlet is in communication with the cavity; an inlet pipe, connected with the first end of the valve body, wherein a pipe opening of the inlet pipe is in communication with the inlet; and a limiting structure arranged between the first end of the valve body and the inlet pipe, the limiting structure is used for limiting a relative position of the inlet pipe relative to the valve body.

The present disclosure is a divisional application of U.S. patent application Ser. No. 17/613,087, filed Nov. 22, 2021, entitled Pilot Valve and Four-way Reversing Valve, which is incorporated by reference in its entirety.

### TECHNICAL FIELD

The present disclosure relates to the technical field of four-way reversing valves, and in particular to a pilot valve and a four-way reversing valve.

### BACKGROUND

Generally, a pilot valve includes a valve body, an end cover, and an inlet pipe. The end cover is arranged at an end of the valve body, and the inlet pipe penetrates into the end cover, as to achieve the communication between the inlet pipe and the valve body.

However, in a technology known to inventors, the end cover is a separately arranged component, a device has many parts, and the end cover is arranged on the valve body by a mode of welding, a production cost of the device is relatively high. Therefore, the technology known to inventors has problems of complex structure and high cost.

### SUMMARY

Some embodiments of the present disclosure provide a pilot valve and a four-way reversing valve, as to solve a problem of complex structure and high cost in a technology known to inventors.

According to some embodiments of the present disclosure, a pilot valve is provided. The pilot valve includes: a valve body, herein the valve body is a cylinder formed by integrally stretching and having an open end and a closed end, the closed end is defined as a first end, the open end is defined as a second end, the first end of the valve body is provided with an inlet, an inside of the valve body is provided with a cavity, and the inlet is in communication with the cavity; an inlet pipe connected with the first end of the valve body, herein a pipe opening of the inlet pipe is in communication with the inlet; and a limiting structure arranged between the first end of the valve body and the inlet pipe, wherein the limiting structure is used for limiting a relative position of the inlet pipe relative to the valve body.

In some embodiments, an end face of the first end of the valve body is provided with a mounting hole section, the mounting hole section extends toward the inside of the valve body, the inlet pipe passes through the mounting hole section, the inlet is located in the mounting hole section, and the limiting structure is located between the mounting hole section and the inlet pipe.

In some embodiments, the mounting hole section has a first end and a second end that are oppositely arranged, the second end of the mounting hole section is located inside the valve body, and a hole wall of the second end of the mounting hole section is bent toward an axial direction of the mounting hole section to form the inlet.

In some embodiments, a cross-sectional size of the inlet pipe near the second end of the mounting hole section is larger than a size of the inlet, and an end portion of the inlet pipe abuts against an end face of the second end of the mounting hole section, as to form the limiting structure.

In some embodiments, the inlet pipe is provided with a second enlarged diameter section, the second enlarged diameter section includes a first section and a second section that are connected to each other, the first section is located at an outer side of the mounting hole section, the second section penetrates into the mounting hole section, a diameter of the first section is larger than a diameter of the second section, and the diameter of the second section is smaller than a hole diameter of the mounting hole section.

In some embodiments, the pilot valve further includes a filter screen, and the filter screen is clamped in the first section.

In some embodiments, the pilot valve further includes a valve core assembly, and the valve core assembly includes: a core iron, movably arranged in the valve body; a bracket, herein the core iron is drivingly connected with the bracket; a slider, arranged on the bracket; and a pressing piece, wherein the pressing piece has a first end and a second end opposite to the first end, the first end of the pressing piece is arranged between the bracket and the core iron, and the second end of the pressing piece abuts against the slider.

In some embodiments, the pilot valve further includes a valve seat, the valve seat is arranged on a side wall of the valve body, the valve seat is sequentially provided with a first valve port, a second valve port, and a third valve port, and the inlet forms a fourth valve port, the slider is movably arranged on the valve seat, and the slider is used to control a communication condition between the first valve port and the third valve port and the second valve port.

Some embodiments of the present disclosure provide a four-way reversing valve, and the four-way reversing valve includes the pilot valve provided above.

In some embodiments, the pilot valve includes a valve body, an inlet pipe and a limiting structure. Wherein, the valve body is a cylinder formed by integrally stretching and having an open end and a closed end, the closed end is defined as a first end, the open end is defined as a second end, the first end of the valve body is provided with an inlet, the valve body is internally provided with a cavity, the inlet is in communication with the cavity, the inlet pipe is connected with the first end of the valve body and a pipe opening of the inlet pipe is in communication with the inlet. In addition, the limiting structure is arranged between the first end of the valve body and the inlet pipe, and the limiting structure may be used for limiting a relative position of the inlet pipe relative to the valve body. The above structure is used without providing an end cover, and components of a device are reduced, thereby the structure of the device is simplified, a cost of the device is reduced, and a working process of welding the end cover may also be eliminated, a cost of the device is further reduced.

### BRIEF DESCRIPTION OF THE DRAWINGS

Drawings of the description for constituting a part of the present disclosure are used to provide further understanding of the present disclosure, and exemplary embodiments of the present disclosure and descriptions thereof are used to explain the present disclosure, and do not constitute improper limitation to the present disclosure. In the drawings:

FIG. 1 shows a structure schematic diagram of a pilot valve provided in Embodiment I of the present disclosure.

FIG. 2 shows a structure schematic diagram of a valve body in FIG. 1.

FIG. 3 shows a cross-sectional view of the valve body in FIG. 1.

FIG. 4 shows another structure schematic diagram of the valve body in FIG. 1.

FIG. 5 shows a structure schematic diagram of a pilot valve provided in Embodiment II of the present disclosure.

FIG. 6 shows a structure schematic diagram of a valve body in FIG. 5.

FIG. 7 shows a cross-sectional view of the valve body in FIG. 5.

FIG. 8 shows another structure schematic diagram of the valve body in FIG. 5.

FIG. 9 shows a structure schematic diagram of an inlet pipe in FIG. 5.

FIG. 10 is a schematic cross-sectional view of a pilot valve provided in Embodiment IV of the present disclosure.

FIG. 11 is an enlarged schematic diagram of a circle part A in FIG. 10.

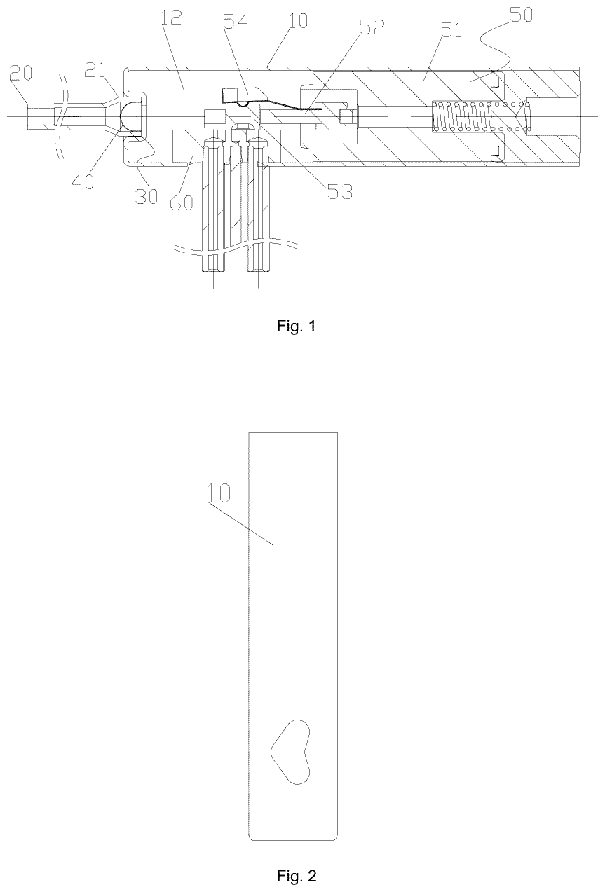

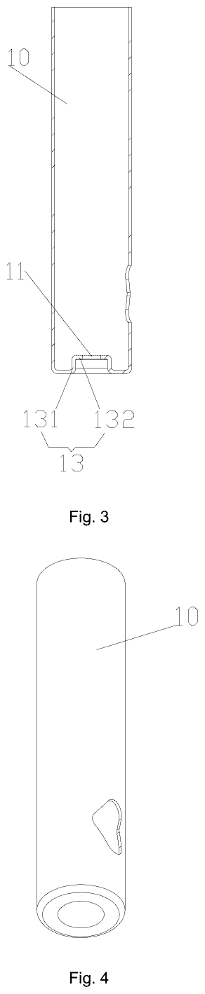

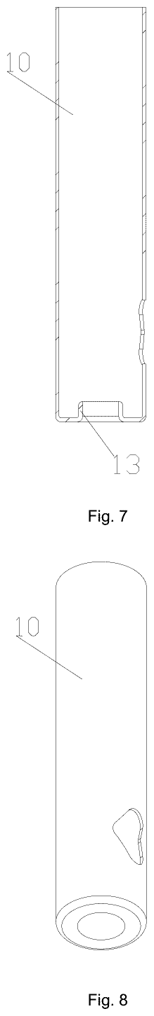

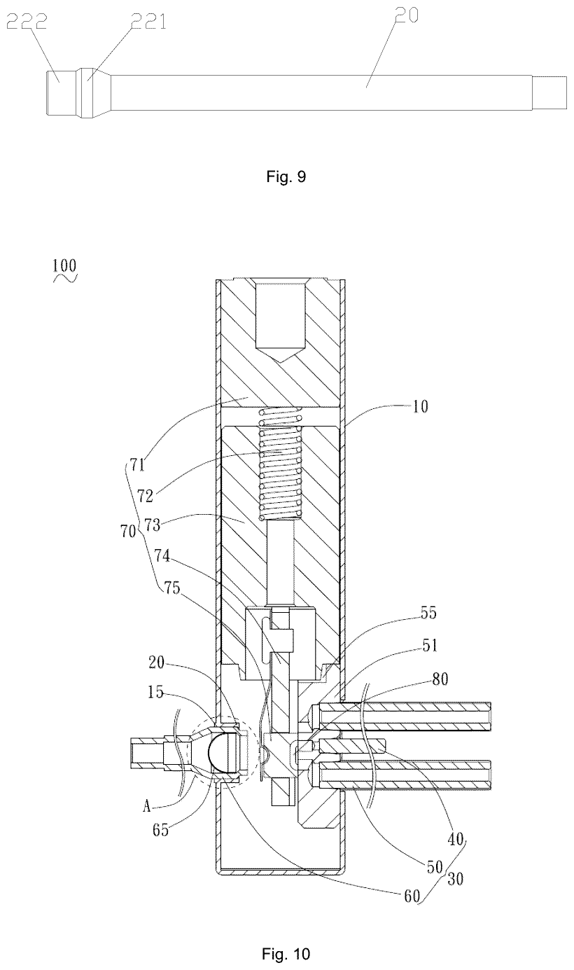

Herein, the drawings of FIG. 1 to FIG. 9 include the following reference signs:

10. Valve body; 11. Inlet; 12. Cavity; 13. Mounting hole section; 131. First end; 132. Second end;

20. Inlet pipe; 21. First enlarged diameter section; 22. Second enlarged diameter section; 221. First section; 222. Second section;

30. Limiting structure; 40. Filter screen;

50. Valve core assembly; 51. Core iron; 52. Bracket; 53. Slider; 54. Pressing piece; and

60. Valve seat.

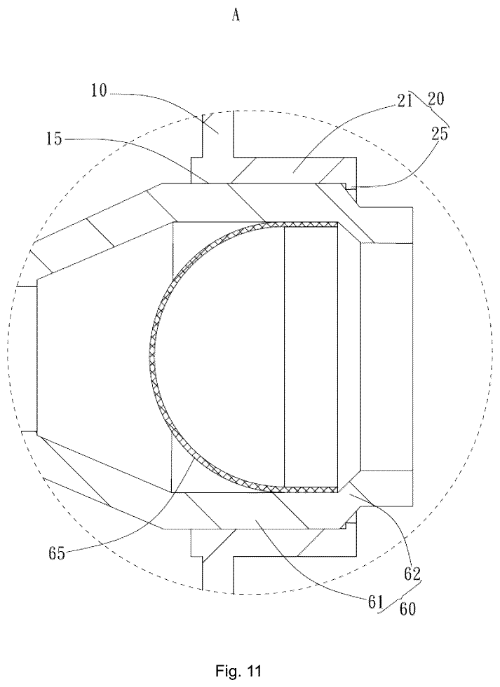

Herein, the drawings of FIG. 10 to FIG. 11 include the following reference signs:

100. Pilot valve;

10. Housing; 15. Mounting hole; 20. Support portion; 21. Extending portion; 25. Clamping portion;

30. Catheter assembly; 40. Air suction pipe; 50. Loop pipe; 51. Fixing seat; 55. Limiting groove; 60. Air exhaust pipe; 61. Inserting portion; 62. Shrinking portion; 65. Filter screen;

70. Control assembly; 71. Top block; 72. Elastic piece; 73. Magnetic attraction piece;

74. Connecting rod; 75. Slider; and 80. Communicating hole.

### DETAILED DESCRIPTION OF THE EMBODIMENTS

Technical schemes in embodiments of the present disclosure are clearly and completely described below in combination with drawings in the embodiments of the present disclosure. Apparently, the described embodiments are only a part of the embodiments of the present disclosure, rather than all of the embodiments. The following description of at least one exemplary embodiment is actually only illustrative, and is by no means as any limitation to the present disclosure and disclosure or use thereof. Based on the embodiments in the present disclosure, all other embodiments obtained by those of ordinary skill in the art without creative work shall fall within a scope of protection of the present disclosure.

As shown in FIG. 1 to FIG. 4, a pilot valve is provided in Embodiment I of the present disclosure, and the pilot valve includes a valve body 10, an inlet pipe 20 and a limiting structure 30. Herein, the valve body 10 is a cylinder formed by integrally stretching and having an open end and a closed end, the closed end is defined as a first end, the open end is defined as a second end, the first end of the valve body 10 is provided with an inlet 11, an inside of the valve body 10 is provided with a cavity 12, the inlet 11 is in communication with the cavity 12, and the inlet pipe 10 is an integrally formed structure. The above structure is used without providing an end cover, and components of a device are reduced, thereby the structure of the device is simplified, and the cost of the device is reduced. In some embodiments, the inlet pipe 20 is connected with the first end of the valve body 10, and a pipe opening of the valve body 10 is in communication with the inlet 11, so that it is guaranteed that a refrigerant may enter the valve body 10 through the inlet pipe 20. In some embodiments, the limiting structure 30 is arranged between the first end of the valve body 10 and the inlet pipe 20, and the limiting structure 30 is used for limiting a relative position of the inlet pipe 20 relative to the valve body 10, as to prevent the size of the inlet pipe 20 stretched into the valve body 10 from being too long, or prevent the inlet pipe 20 from being detached from the valve body 10.

The pilot valve provided in this embodiment is applied, the valve body 10 is integrally stretched to form the cylinder of which one end is opened and the other end is closed, thus there is no need to arrange the end cover, the components of the device are reduced, thereby the structure of the device is simplified, the cost of the device is reduced, and a working process of welding the end cover may also be eliminated, the cost of the device is further reduced. However, in a technology known to inventors, the end cover is welded on the valve body 10, and there is a risk of leakage at a welding place. In this embodiment, the valve body 10 of the pilot valve is an integrally formed structure, and the pilot valve does not have the risk of leakage, so a quality control cost in the production is reduced.

In some embodiments, an end face of the first end of the valve body 10 is provided with a mounting hole section 13, and the mounting hole section 13 extends toward the inside of the valve body 10. Through enabling the inlet pipe 20 to insert into the mounting hole section 13, the assembly of the inlet pipe 20 and the valve body 10 is achieved. Herein, the inlet 11 is located in the mounting hole section 13, and the limiting structure 30 is located between the mounting hole section 13 and the inlet pipe 20. In this way, the limiting structure 30 is used for limiting a relative position of the inlet pipe 20 relative to the valve body 10, and communicating the inlet pipe 20 and the valve body 10. In this embodiment, the inlet pipe 20 is inserted into the mounting hole section 13 by a mode of interference fit.

Wherein, the mounting hole section 13 has a first end 131 and a second end 132 opposite to the first end 131, the first end 131 of the mounting hole section 13 is connected with an end wall of the valve body 10, and the second end 132 of the mounting hole section 13 is located inside the valve body 10, the inlet pipe 20 is inserted in the mounting hole section 13, so that the communication between the inlet pipe 20 and the valve body 10 is achieved. Wherein, a hole wall of the second end 132 of the mounting hole section 13 is bent in an axial direction of the mounting hole section 13 to form the inlet 11, and the pipe opening of the inlet pipe 20 communicates with the inlet 11.

In some embodiments, a cross-sectional size of the inlet pipe 20 near the second end 132 of the mounting hole section 13 is larger than a size of the inlet 11, and an end portion of the inlet pipe 20 abuts against an end face of the second end 132 of the mounting hole section 13, as to form the limiting structure 30. The above structure is adopted, the end face of the second end 132 of the mounting hole section 13 is used for limiting the inlet pipe 20, as to prevent the size of the inlet pipe 20 stretched into the valve body 10 from being too long. After the inlet pipe 20 is inserted into the mounting hole section 13, the inlet pipe 20 is further fixed by a mode of welding, as to prevent the inlet pipe 20 from being detached from the mounting hole section 13.

In some embodiments, the inlet pipe 20 is provided with a first enlarged diameter section 21, and the first enlarged diameter section 21 is arranged close to the valve body 10. Specifically, the first enlarged diameter section 21 penetrates into the mounting hole section 13. Wherein, the pilot valve further includes a filter screen 40, and the filter screen 40 is used to filter impurities in the refrigerant, as to prevent the impurities in the refrigerant from blocking the pilot valve. In some embodiments, the filter screen 40 is arranged in the first enlarged diameter section 21, and the filter screen 40 abuts against the end face of the second end 132 of the mounting hole section 13. The above structure is adopted, the end face of the second end 132 of the mounting hole section 13 is used for limiting the filter screen 40, as to prevent the filter screen 40 from being separated from the inlet pipe 20. However, in the technology known to inventors, the filter screen is usually arranged in the valve body 10, and not in the inlet pipe 20. In the embodiments, through enabling the filter screen 40 to be pressed into the inlet pipe 20, it is convenient to disassemble and assemble the filter screen 40, and convenient for the subsequent maintenance.

In some embodiments, the pilot valve further includes a valve core assembly 50, and the valve core assembly 50 includes a core iron 51, a bracket 52, a slider 53 and a pressing piece 54. Wherein, the core iron 51 is movably arranged in the valve body 10, the core iron 51 is drivingly connected with the bracket 52, and the core iron 51 is used to drive the bracket 52 to move in the valve body 10. In some embodiments, the slider 53 is arranged on the bracket 52, and under a drive of the bracket 52, the slider 53 is moved relative to a plurality of valve ports, as to control a communication condition between the plurality of the valve ports. Herein, the pressing piece 54 has a first end and a second end that are oppositely arranged, the first end of the pressing piece 54 is arranged between the bracket 52 and the core iron 51, and the second end of the pressing piece 54 abuts against the slider 53.

In some embodiments, the pilot valve further includes a valve seat 60, the valve seat 60 is arranged on a side wall of the valve body 10, the valve seat 60 is sequentially provided with a first valve port, a second valve port, and a third valve port, and the inlet 11 forms a fourth valve port, the slider 53 is movably arranged on the valve seat 60, and the slider 53 is used to control a communication condition between the first valve port and the second valve port and the communication condition between the third valve port and the second valve port. While it is necessary to switch an operating mode of the pilot valve, the core iron 51 is controlled to move in the valve body 10, so that the core iron 51 drives the slider 53 to move through the bracket 52 relative to the first valve port, the second valve port, and the third valve, as to achieve the switching of the operating mode.

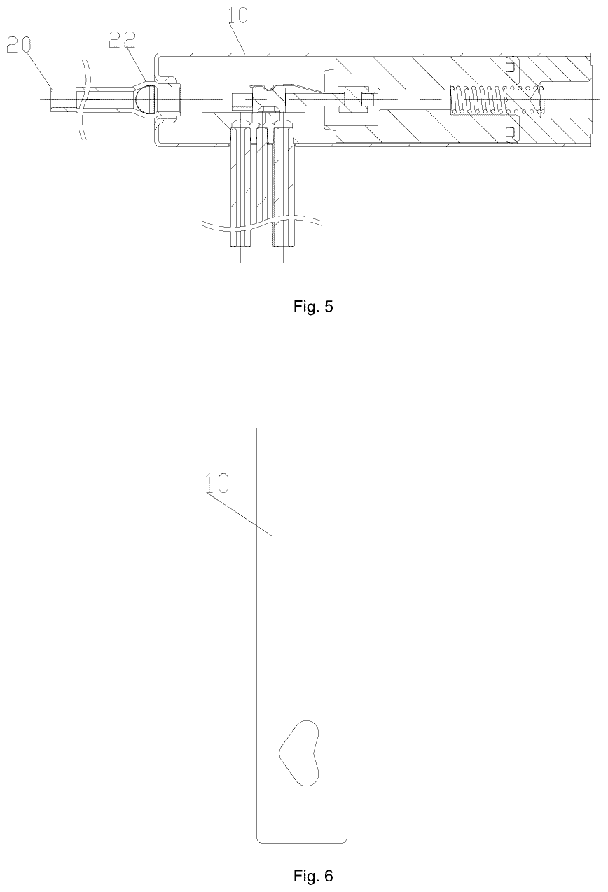

As shown in FIG. 5 to FIG. 9, a pilot valve is provided in Embodiment II of the present disclosure. Compared with Embodiment I, the pilot valve provided in Embodiment II is different in that, in Embodiment II, the inlet pipe 20 is provided with a second enlarged diameter section 22, and the second enlarged diameter section 22 includes a first section 221 and a second section 222 that are connected to each other. Specifically, the first section 221 is located at an outer side of the mounting hole section 13, the second section 222 penetrates into the mounting hole section 13, and a diameter of the first section 221 is larger than a diameter of the second section 222, and the diameter of the second section 222 is smaller than a hole diameter of the mounting hole section 13. The above structure is adopted, after the inlet pipe 20 is inserted into the mounting hole section 13, the first section 221 is used for limiting the inlet pipe 20, as to prevent the size of the inlet pipe 20 stretched into the valve body 10 from being too long. After the second section 222 is inserted into the mounting hole section 13, the inlet pipe 20 is further fixed by the mode of welding, as to prevent the inlet pipe 20 from being detached from the mounting hole section 13.

In this embodiment, the pilot valve further includes a filter screen 40, and the filter screen 40 is clamped in the first section 221. The above structure is adopted, there is no need to provide other limiting structures for the filter screen 40, and a difference between the diameter sizes of the first section 221 and the second section 222 is used to clamp the filter screen 40 in the first section 221, so as to prevent the filter screen 40 from being separated from the inlet pipe 20.

A four-way reversing valve is provided in Embodiment III of the present disclosure, and the four-way reversing valve includes the pilot valve provided above.

Through a device provided in this embodiment, the valve body 10 is arranged as a cylinder formed by integrally stretching and having an open end and a closed end, thus an end cover does not need to be arranged, components of the device are reduced, thereby the structure of the device is simplified, the cost of the device is reduced, and a working process of welding the end cover is also eliminated, so the cost of the device is further reduced.

Please refer to FIG. 10 and FIG. 11, a pilot valve 100 provided in Embodiment IV of the present disclosure includes a housing 10, a catheter assembly 30 connected with the housing 10, and a control assembly 70 connected with the housing 10; and the pilot valve 100 correspondingly communicates with the external four-way reversing valve (unshown in the figure), and the pilot valve 100 is used to control a circulation direction of the refrigerant in an air-conditioning circulation system.

The housing 10 is in a shape of a hollow cylinder and extends in a vertical direction, and a side of the housing 10 is provided with a mounting hole 15; the mounting hole 15 communicates with inner and outer two sides of the housing 10 in the shape of a circular through hole; and the housing 10 is provided with a support portion 20, the support portion 20 is arranged around the mounting hole 15, the support portion 20 extends from the mounting hole 15 to the inside of the housing 10, and the support portion 20 extends in a horizontal direction. In this embodiment, the support portion 20 includes an extending portion 21 and a clamping portion 25; the extending portion 21 is integrally connected with the housing 10, the extending portion 21 is approximately ring-shaped and extends in the horizontal direction, the extending portion 21 extends inwards from the housing 10, and the extending portion 21 is surrounded at an outer side of the mounting hole 15; and the clamping portion 25 is arranged at an end, inserted into the housing 10, of the extending portion 21, and the clamping portion 25 is arranged in the form of a reduced diameter from a tail end of the extending portion 21.

In some embodiments, the catheter assembly 30 is connected with the housing 10, and the catheter assembly 30 includes an air suction pipe 40 connected with the housing 10, a loop pipe 50 respectively arranged on both sides of the air suction pipe 40, and an air exhaust pipe 60 inserted in the mounting hole 15; the air suction pipe 40 is in the shape of a circular pipe and extends in the horizontal direction, the air suction tube 40 is correspondingly arranged on a side of the housing 10, and an end of the air suction pipe 40 is correspondingly inserted in the housing 10; the loop pipe 50 is in the shape of a circular pipe and is arranged in the horizontal direction, an arrangement position of the loop pipe 50 corresponds to an arrangement position of the air suction pipe 40, and one end of the loop pipe 50 is correspondingly inserted in the housing 10; the air exhaust pipe 60 extends in the horizontal direction, one end of the air exhaust pipe 60 is correspondingly inserted into the mounting hole 15, an outer side wall of the air exhaust pipe 60 is attached to the support portion 20, and the air exhaust pipe 60 abuts against the clamping portion 25 correspondingly. In this embodiment, the number of the loop pipes 50 is two; the loop pipes 50 and the air suction tube 40 are arranged side by side, the two loop pipes 50 are respectively arranged on upper and lower two sides of the air suction pipe 40, and the air suction pipe 40 is respectively communicated with each loop pipe 50, as to control different circulation loops, so that a working state of the four-way reversing valve is changed, thereby a circulation direction of the refrigerant in an air-conditioning circulation system is controlled.

In some embodiments, the air exhaust pipe 60 includes an inserting portion 61 and a shrinking portion 62; the inserting portion 61 is approximately ring-shaped and extends in the horizontal direction, a size of the inserting portion 61 corresponds to the support portion 20, and the inserting portion 61 is connected and fixed with the support portion 20 correspondingly; the shrinking portion 62 extends from the inserting portion 61 to the inside of the housing 10, a cross-sectional size of the shrinking portion 62 is gradually decreased in a direction from an outside of the housing 10 to the inside of the housing 10, and the shrinking portion 62 abuts against the clamping portion 25 correspondingly, as to locate a mounting position of the air exhaust pipe 60. In some embodiments, an inside of the air exhaust pipe 60 is provided with a filter screen 65; the filter screen 65 is arranged in an arc-shaped structure, the shrinking portion 62 clamps the filter screen 65 in the air exhaust pipe 60, and the filter screen 65 protrudes in a direction from the shrinking portion 62 to the inserting portion 61. In this embodiment, an arrangement position of the air exhaust pipe 60 corresponds to an arrangement position of the air suction pipe 40, and the air exhaust pipe 60 and the air suction pipe 40 are respectively arranged on both sides of the housing 10.

In some embodiments, the control assembly 70 is connected with the housing 10 correspondingly, and the control assembly 70 includes a top block 71 connected with the housing 10, an elastic piece 72 connected with the top block 71, a magnetic attraction piece 73 connected with the elastic piece 72, a connecting rod 74 connected with the magnetic attraction piece 73, and a slider 75 connected with the connecting rod 74. The top block 71 is approximately in the shape of a cylinder and extends in a vertical direction, the top block 71 is arranged on a top of the housing 10, and the top block 71 seals the housing 10, thereby it is guaranteed that a relatively sealed space is formed inside the housing 10; the elastic piece 72 extends in the vertical direction, a top of the elastic piece 72 is connected with a bottom of the top block 71, a bottom of the elastic piece 72 is correspondingly inserted in the magnetic attraction piece 73, and the elastic piece 72 is elastically supported between the top block 71 and the magnetic attraction piece 73; the magnetic attraction piece 73 is slidably arranged inside the housing 10 correspondingly, the magnetic attraction piece 73 is correspondingly moved in the vertical direction, the magnetic attraction piece 73 is made of a magnetic material, and an end, close to the top block 71, of the external housing 10 is provided with an electromagnetic coil, thereby a magnetic attraction force to the magnetic attraction piece 73 is controlled by controlling an energization state of the electromagnetic coil, and the magnetic attraction force may make the magnetic attraction piece 73 move toward the top block 71; the connecting rod 74 is in the shape of a circular straight rod and is arranged in the vertical direction, the connecting rod 74 extends downwards from the magnetic attraction piece 73, and the magnetic attraction piece 73 drives the connecting rod 74 to move; and the slider 75 correspondingly sleeves at an outer side of the connecting rod 74, the connecting rod 74 drives the slider 75 to move, and a moving direction of the slider 75 is different from the arrangement direction of the air exhaust pipe 60. In this embodiment, the arrangement direction of the air exhaust pipe 60 is perpendicular to the moving direction of the slider 75; and the elastic piece 72 is a spring.

In some embodiments, the slider 75 is provided with a communicating hole 80, two ends of the communicating hole 80 are respectively corresponding to the air suction pipe 40 and the loop pipe 50, the communicating hole 80 is arranged in a U-shaped structure, and the communicating hole 80 is used to communicate the air suction pipe 40 and one of the two loop pipes 50. In some embodiments, a connection place, corresponding to the housing 10, between the air suction pipe 40 and the loop pipe 50 is provided with a fixing seat 51; the fixing seat 51 is connected and fixed with an inner side wall of the housing 10, the air suction pipe 40 and the loop pipe 50 correspondingly pass through the housing 10 and are connected and fixed with the fixing seat 51, a side face of the fixing seat 51 is correspondingly attached to a side face of the slider 75, thereby it is guaranteed that the air suction pipe 40 is communicated with the loop pipe 50 by the communicating hole 80. In this embodiment, the fixing seat 51 is provided with a limiting groove 55; and the limiting groove 55 is arranged at an end, closes to the magnetic attraction piece 73, of the fixing seat 51, the limiting groove 55 extends downwards from a top end of the fixing seat 51, and the magnetic attraction piece 73 abuts against the limiting groove 55 correspondingly, thereby the movement of the magnetic attraction piece 73 is limited.

A working principle of the pilot valve 100 in this embodiment is as follows: by arranging the electromagnetic coil externally, while the electromagnetic coil is energized, the magnetic attraction piece 73 is attracted to move upwards, the elastic piece 72 is compressed, the slider 75 is driven to move upwards, the communicating hole 80 communicates the air suction pipe 40 and the loop pipe 50 at the top, and at the same time, the loop pipe 50 at the bottom is exposed to communicate with the air exhaust pipe 60; while it is necessary to switch an operating state, the energization to the electromagnetic coil is stopped, the magnetic attraction piece 73 is no longer subject to the electromagnetic attraction force, and then the magnetic attraction piece 73 is pushed downwards under an action of the elastic piece 72, the slider 75 is driven to move downwards, the communicating hole 80 communicates the air suction pipe 40 and the loop pipe 50 at the bottom, and at the same time, the loop pipe 50 at the top is exposed to communicate with the air exhaust pipe 60, as to complete the switching of the circulation loop. Since the support portion 20 is provided with the extending portion 21 and the clamping portion 25, the housing 10 is conveniently connected with the air exhaust pipe 60, the support portion 20 is conveniently welded and fixed with the air exhaust pipe 60, and the structure of the support portion 20 is correspondingly processed by using a hot-melt drill processing technology, and the clamping portion 25 is arranged to conveniently remove an oxide layer generated during the hot-melt drill processing, so a welding strength is guaranteed; by arranging the shrinking portion 62 at an end portion of the air exhaust pipe 60, it is guaranteed that the filter screen 65 is fixed in the air exhaust pipe 60, and it may also prevent the filter screen 65 from being missed during an assembly process, the automatic assembly is conveniently achieved; and through the structure in which the arrangement direction of the air exhaust pipe 60 is perpendicular to the moving direction of the slider 75, an airflow is prevented from driving the slider 75 to move, thereby a problem that the slider 75 is blown off or turned over by the airflow is prevented, so a working reliability of the pilot valve 100 is improved.

The above pilot valve 100, by arranging the mounting hole 15 on one side of the housing 10 and inserting the air exhaust pipe 60 into the mounting hole 15, guarantees that the moving direction of the slider 75 is different from the arrangement direction of the air exhaust pipe 60, thereby the airflow is prevented from moving along the moving direction of the slider 75, and the slider 75 is prevented from being blown off or turned over; and by arranging the support portion 20 on the mounting hole 15, a connection strength between the housing 10 and the air exhaust pipe 60 is improved, and the support portion 20 has a positioning function for mounting of the air exhaust pipe 60, so the automatic assembly is conveniently achieved.

The above are only some embodiments of the present disclosure, and are not intended to limit the present disclosure. For those skilled in the art, the present disclosure may have various modifications and changes. Any modifications, equivalent replacements, improvements and the like made within the spirit and principle of the present disclosure shall be included in a scope of protection of the present disclosure.

What is claimed is:

1. A pilot valve, wherein the pilot valve comprises:
a valve body, wherein the valve body is a cylinder formed by integrally stretching and having an open end and a closed end, the closed end is defined as a first end, the open end is defined as a second end, the first end of the valve body is provided with an inlet, an inside of the valve body is provided with a cavity, and the inlet is in communication with the cavity;
an inlet pipe, connected with the first end of the valve body, wherein a pipe opening of the inlet pipe is in communication with the inlet; and
a limiting structure, arranged between the first end of the valve body and the inlet pipe, wherein the limiting structure is used for limiting a relative position of the inlet pipe relative to the valve body;
wherein an end face of the first end of the valve body is provided with a mounting hole section, the mounting hole section extends toward the inside of the valve body, the inlet pipe passes through the mounting hole section, the inlet is located in the mounting hole section, and the limiting structure is located between the mounting hole section and the inlet pipe;
wherein the inlet pipe is provided with a second enlarged diameter section, the second enlarged diameter section comprises a first section and a second section that are connected to each other, the first section is located at an outer side of the mounting hole section, the second section penetrates into the mounting hole section, a diameter of the first section is larger than a diameter of the second section, and the diameter of the second section is smaller than a hole diameter of the mounting hole section.

2. The pilot valve as claimed in claim 1, wherein the mounting hole section has a first end and a second end that are oppositely arranged, the second end of the mounting hole section is located inside the valve body, and a hole wall of the second end of the mounting hole section is bent toward an axial direction of the mounting hole section to form the inlet.

3. The pilot valve as claimed in claim 2, wherein a cross-sectional size of the inlet pipe near the second end of the mounting hole section is larger than a size of the inlet, and an end portion of the inlet pipe abuts against an end face of the second end of the mounting hole section, as to form the limiting structure.

4. The pilot valve as claimed in claim 1, wherein the pilot valve further comprises a filter screen, and the filter screen is clamped in the first section.

5. The pilot valve as claimed in claim 1, wherein the pilot valve further comprises a valve core assembly, and the valve core assembly comprises:
a core iron, movably arranged in the valve body;
a bracket, wherein the core iron is drivingly connected with the bracket;
a slider, arranged on the bracket; and
a pressing piece, wherein the pressing piece has a first end and a second end opposite to the first end, the first end of the pressing piece is arranged between the bracket and the core iron, and the second end of the pressing piece abuts against the slider.

6. The pilot valve as claimed in claim 5, wherein the pilot valve further comprises a valve seat, wherein the valve seat is arranged on a side wall of the valve body, the valve seat is sequentially provided with a first valve port, a second valve port, and a third valve port, and the inlet forms a fourth valve port, the slider is movably arranged on the valve seat, and the slider is used to control a communication condition between the first valve port and the third valve port and the second valve port.

7. A four-way reversing valve, wherein the four-way reversing valve comprises the pilot valve as claimed in claim 1.
